(19) United States
(12) Patent Application Publication
(10) Pub. No.: US 2002/0015829 A1
(43) Pub. Date: Feb. 7, 2002

(54) Heat transfer paper for label made of thermosetting material and method of manufacturing the same

(76) Inventor: Kyu Hwan Kim, Seoul (KR)

Correspondence Address: JACOBSON HOLMAN PLLC, 400 SEVENTH STREET N.W., SUITE 600, WASHINGTON, DC, 20004, US

(21) Appl. No.: 09/906,740

(22) Filed: Jul. 18, 2001

(30) Foreign Application Priority Data
Aug. 5, 2000 (KR) 2000-45510

(51) Int. Cl. B41M 3/12; B32B 27/14; B29C 39/12

(52) U.S. Cl. 428/195; 427/152; 264/245; 264/246; 264/255

(57) ABSTRACT

Disclosed is heat transfer paper for a label made of a thermosetting material and a method of manufacturing the same, and more particularly, to heat transfer paper for a label made of a thermosetting material and a method of manufacturing the same which is capable of providing a substantially complete three-dimensional effect to the label that is attached on various kinds of articles such as clothing and adopting heat adhesion manner on a material to which the label adheres. Generally, in case where a thermal bond is applied on the silicone rubber, however, there occurs a problem that the adhesive force is remarkably weakened due to the oil contained in the silicone rubber. Therefore, the heat transfer paper according to the present invention can be provided with a silicone rubber layer formed by a depressed mold and a color layer on the surface of the silicone rubber layer, thereby achieving a high quality of label having various colors and a sophisticated outer appearance line. In addition, before a silicone coupling layer applied in a substantially thin thickness on the color layer is hardened a thermal bond layer is applied and hardened with the silicone coupling layer, such that it can be firmly attached on the silicone coupling layer. This enables the mold releasing property of the silicone to be substantially suppressed, thereby enhancing the adhesive force of the silicone rubber layer. This ensures that the competitiveness of the label will be greatly enhanced.

### BACKGROUND OF THE INVENTION

1. Field of the Invention

The present invention relates to heat transfer paper for a label made of a thermosetting material and a method of manufacturing the same, and more particularly, to heat transfer paper for a label made of a thermosetting material and a method of manufacturing the same which is capable of providing a substantially complete three-dimensional effect to the label that is attached on various kinds of articles such as clothing and adopting heat adhesion manner on a material to which the label is attached.

2. Background of the Related Art

In order for a thermosetting material such as silicone rubber to have a three-dimensional label, generally, there is provided a conventionally developed method where the silicone rubber is heat-transferred on a mold paperboard that is once removed after the use, thereby allowing the label to be three-dimensionally extruded.

In more detail, the label is manufactured in such a manner that a thermal bond applied on the reverse side of the silicone rubber is permeated into a material by means of a heat press and then adheres thereto, thereby forming a silicone rubber layer having a predetermined shape on the material. Therefore, even though the material is contracted or extended, the deformation of the label can be prevented with the help of the flexibility of the silicone rubber.

In case where the thermal bond is applied on the silicone rubber, however, there occurs a problem that the adhesive force is remarkably weakened due to the oil contained in the silicone rubber. More particularly, if heat by the heat press is applied to the label, the thermal bond is melt and permeated into the material, with a result that a slack is generated between the silicone rubber that is not deformed against heat and the thermal bond layer that is deformed against heat, thereby making it possible to easily separate the silicone rubber from the thermal bond layer.

Moreover, the silicone rubber label exhibits flexible buffering capability and three-dimension effect but doesn't have various colors and ornamental beauty, thereby failing to be high in quality.

### SUMMARY OF THE INVENTION

Accordingly, the present invention is directed to heat transfer paper for a label made of a thermosetting material and a method of manufacturing the same that substantially obviates one or more problems due to limitations and disadvantages of the related art.

An object of the present invention is to provide heat transfer paper for a label made of a thermosetting material and a method of manufacturing the same which is capable of providing solid adhesion between a silicone rubber layer that is formed for the outer appearance of the label and a bond layer and having various colors and ornamental beauty, thereby enhancing the quality of the label.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve this object and other advantages and in accordance with the purpose of the invention, as embodied and broadly described herein, there is provided heat transfer paper for a label made of a thermosetting material, which includes: a silicone rubber layer adapted to be protruded in a predetermined shape by means of a depressed mold; a color layer applied in a substantially thin thickness on the reverse side of the silicone rubber layer; a coupling layer applied in a substantially thin thickness on the reverse side of the color layer; and a thermal bond layer applied before the coupling layer is hardened and made of a thermoplastic resin.

In another aspect of the present invention, there is provided a method of manufacturing heat transfer paper for a label made of a thermosetting material, which includes the steps of: pouring silicone rubber into a depressed groove of a predetermined shape formed on a depressed mold, thereby forming a silicone rubber layer; applying colored silicone rubber in a substantially thin thickness to the surface of the silicone rubber layer hardened, thereby forming a color layer; applying silicone rubber in a substantially thin thickness to the surface of the color layer hardened, thereby forming a coupling layer; and applying a thermoplastic resin before the coupling layer is hardened, thereby forming a thermal bond layer, whereby the coupling layer is hardened with the thermal bond layer, thereby ensuring more rigid adhesion between the coupling and the thermal bond layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A to 1H are sectional views illustrating a sequential process of manufacturing heat-transfer paper for a label made of a thermosetting material according to the present invention;

FIGS. 2A to 2E are sectional views illustrating a process where base paper with an adhesive layer thereon adheres to the heat transfer paper manufactured and is rigidly attached to a material; and

FIG. 3 is a perspective view illustrating a state where a label on which the heat transfer paper manufactured according to the present invention is applied is attached on the material.

### DETAILED DESCRIPTION OF THE PREFERRED EMBODIMENTS

Reference will now be made in detail to the preferred embodiments of the present invention, examples of which are illustrated in the accompanying drawings.

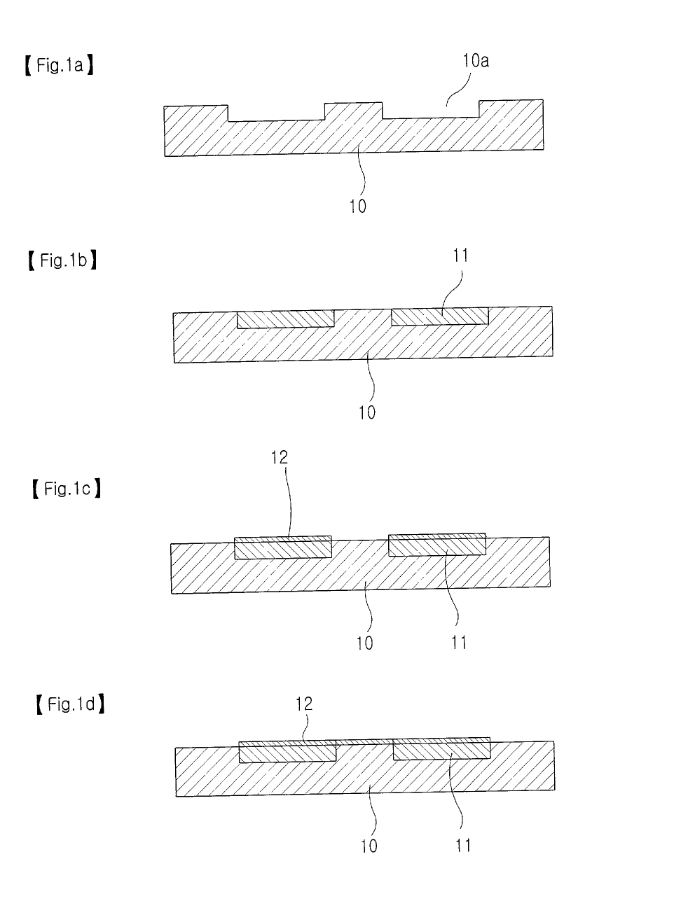

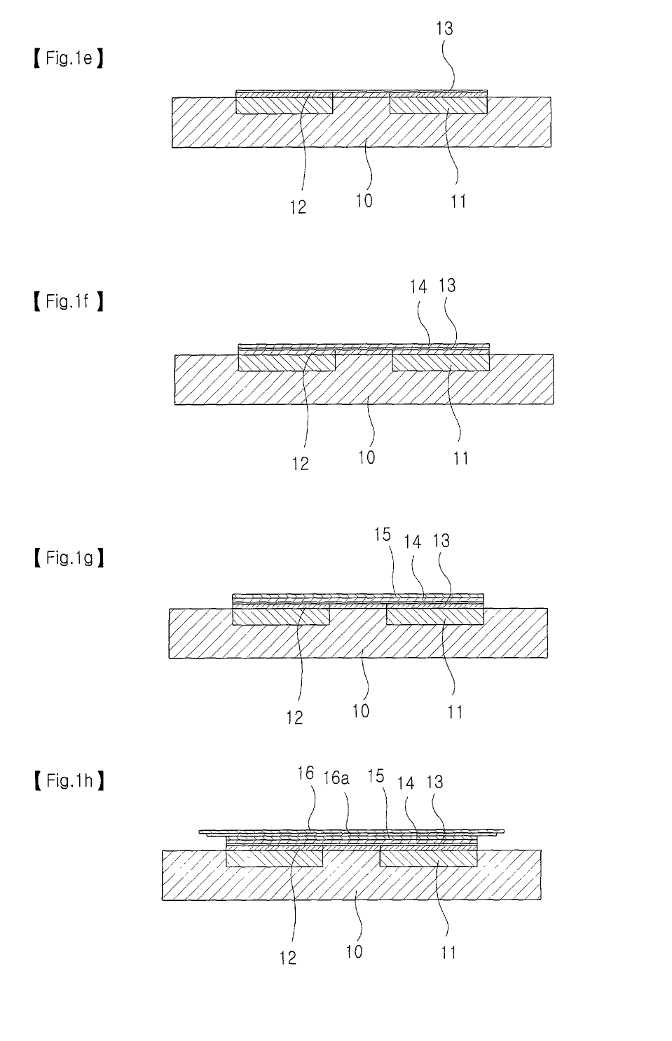

As shown in FIGS. 1A and 1B, silicone is poured into a depressed groove 10a of a predetermined shape formed on a depressed mold 10, thereby forming a silicone rubber layer 11.

At this time, the predetermined shape of the depressed groove 10a is taken by specific characters or figures constituting a desired label. In case where the body of label is formed by using the depressed groove 10a, there are some advantages that the outer appearance line of the label is more fine and sophisticated when compared with the printing method using silicone rubber by a silk print.

Next, as shown in FIG. 1C, if the silicone rubber layer 11 poured into the depressed groove 10a is hardened, a color silicone containing pigment or dye is applied in a substantially thin thickness on the surface of the silicone rubber layer 11, thereby forming a color layer 12.

The color layer 12 is applied to have a corresponding shape to the silicone rubber layer 11 by using a silk screen printing method. At this time, the color layer 12 is printed several times in accordance with the shape of the figures or characters of the label. In some cases, on the other hand, the color layer 12 may be formed between the silicone rubber layers 11, that is, on the protruded portion between the characters or figures, as shown in FIG. 1D.

Next, as shown in FIG. 1E, if the color layer 12 made of the silicone is hardened, silicone is applied in a substantially thin thickness on the surface of the color layer 12, thereby forming a coupling layer 13.

Subsequent to the formation of the coupling layer 13, as shown in FIG. 1G, a thermoplastic resin is applied before the silicone coupling layer 13 is hardened, thereby forming a thermal bond layer 15.

In this case, before the coupling layer 13 applied in the substantially thin thickness is hardened the thermoplastic resin is applied and hardened with the thermal bond layer 15 and the coupling layer 13, with a result that the thermal bond layer 15 is rigidly attached on the coupling layer 13 and well secured thereto.

After the silicone is hardened it exhibits a high mold release characteristic, such that it is very difficult to attach any material on the silicone. However, the thermal bond layer 15 is applied before the coupling layer 13 is hardened and then hardened with the coupling layer 13, such that it can be fixedly attached on the coupling layer 13 before the generation of the mold releasing of the silicone.

On the other hand, between the coupling layer 13 and the thermal bond layer 15 there is provided a thermoplastic resin layer 14, as shown in FIG. 1F.

That is to say, before the coupling layer 13 is hardened, the thermoplastic resin, which is made of the same material such as polyester, urethane or epoxy as the thermoplastic resin of the thermal bond layer 15, is applied thereon, thereby forming the thermoplastic resin layer 14. Then, if the thermoplastic resin layer 14 is hardened, the thermal bond layer 15 is formed by applying the thermoplastic resin on the thermoplastic resin layer 14.

The thermoplastic resin layer 14 is applied on the surface of the coupling layer 13 that is not hardened yet, such that it can be rigidly attached on the coupling layer 13. Moreover, the thermoplastic resin layer 14 is made of the same material as the thermal bond layer 15 formed on the surface thereof, such that it can be firmly attached to the thermal bond layer 15. In more detail, the thermal bond layer 15 is melt by the operation of a heat press and is partially permeated into the material of a product, such that even if the adhesive force of the thermal bond layer 15 is reduced, the thermoplastic resin layer 14 and the thermal bond layer 15, which are the same material, can maintain a substantially very strong adhesive force therebetween, thereby effectively preventing a label from being undesirably separated.

After the completion of the above-mentioned process, if the label 1 is formed, base paper 16 with an adhesive layer 16a is attached on the surface of the thermal bond layer 15 and thus, the label 1 is separated from the depressed mold 10. Next, the label 1 turns over, and release paper 17 with a heat-resistant adhesive layer 17a is attached on the surface of the silicone rubber layer 11, thereby finally producing heat transfer paper for the label.

The base paper 16 with the adhesive layer 16a and the release paper 17 with the heat-resistant adhesive layer 17a are generally employed at the time when several characters and figures are attached on the material 18, at a time. However, in case where the label is comprised of a single character or figure, the label 1 is directly separated from the depressed mold 10 without any formation of the base paper 16 and the release paper 17.

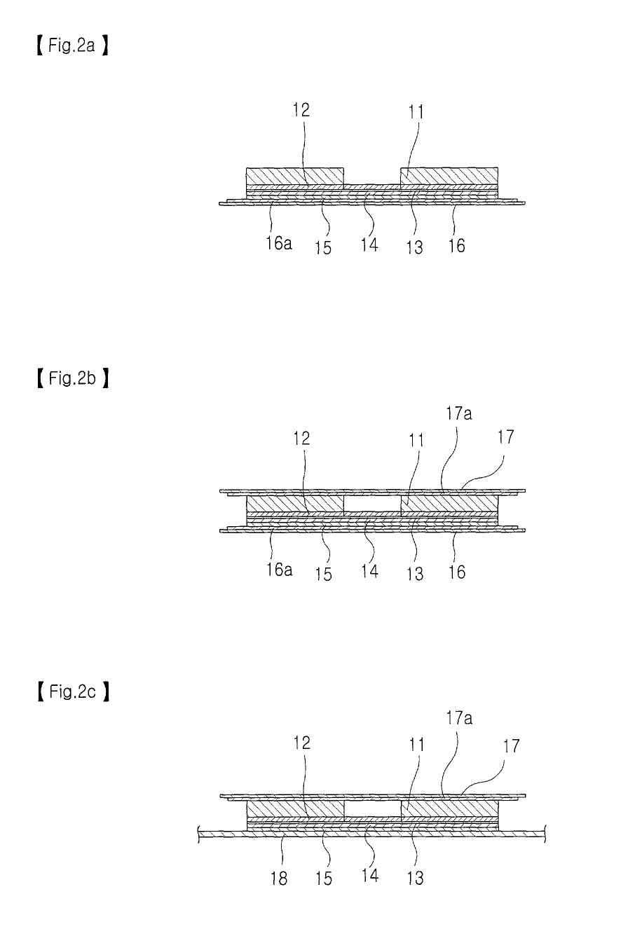

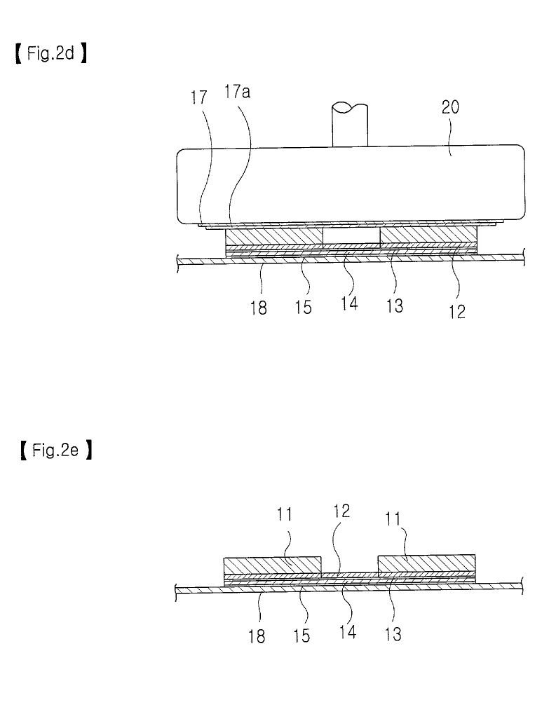

In order to attach the completed heat transfer paper for the label on the material 18, as shown in FIGS. 2C and 2D the base paper 16 is separated from the thermal bond layer 15 and then, the thermal bond layer 15 is disposed on the material 18 such as cloth or leather. Next, the release paper 17 disposed on the uppermost portion of the heat transfer paper is pressed by means of an iron or heat press 20.

At this time, the thermal bond layer 15 is melted by the application of heat in a range of 150° C. to 200° C. by the heat press 20 and thus permeated into the material 18, with a consequence that the silicone rubber layer 11 is firmly attached on the material 18.

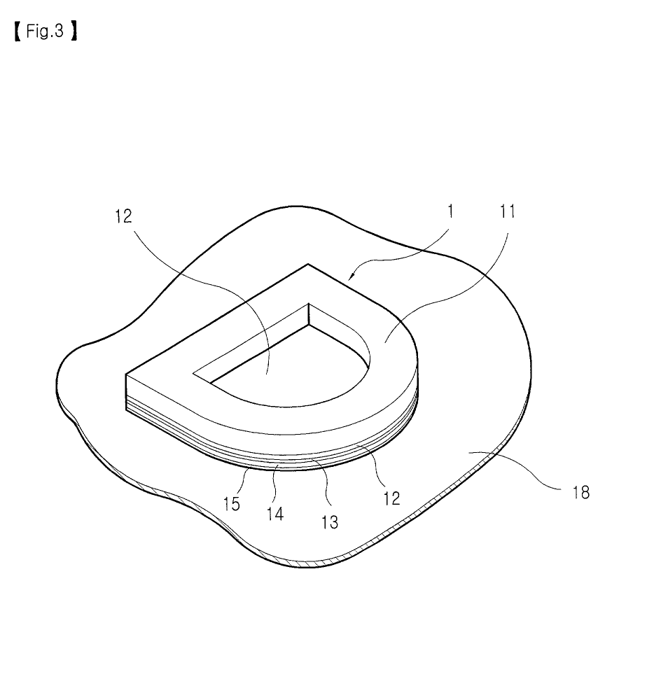

When the silicone rubber layer 11 is firmly attached on the material 18, if the release paper 17 is removed, the light from the colors generated from the color layer 12 is reflected and emitted through the silicone rubber layer 11 extruded three-dimensionally, as shown in FIGS. 2E and 3, thereby achieving the label 1 with a sophisticated outer appearance line that is high in quality. With the heat transfer paper for the label according to the present invention, therefore, all of the problems suffered conventionally can be eliminated.

In addition, the flexibility the silicone rubber layer 11 protruded three-dimensionally has can cope with the contraction or extension of the material 18, thereby preventing the label 1 from being separated from the material 18. Even when the material 18 with the label is cleaned or ironed, the deformation of the label 1 can be substantially reduced, thereby maintaining the original shape of the label 1 without any change. This ensures that the competitiveness of the label will be greatly enhanced.

As discussed above, heat transfer paper for a label made of a thermosetting material and a method of manufacturing the same according to the present invention can be provided with a silicone rubber layer formed by a depressed mold and a color layer on the surface of the silicone rubber layer, thereby achieving a high quality of label having various colors and a sophisticated outer appearance line. In addition, before a coupling layer applied in a substantially thin thickness on the color layer is hardened a thermal bond layer is applied and hardened with the coupling layer, such that it can be firmly attached on the coupling layer. This enables the mold releasing property of the silicone to be substantially suppressed, thereby enhancing the adhesive force of the silicone rubber layer. This ensures that the competitiveness of the label will be greatly enhanced.

The forgoing embodiments are merely exemplary and are not to be construed as limiting the present invention. The present teachings can be readily applied to other types of devices. The description of the present invention is intended to be illustrative, and not to limit the scope of the claims. Many alternatives, modifications, and variations will be apparent to those skilled in the art.

What is claimed is:

1. A method of manufacturing heat transfer paper for a label made of a thermosetting material, said method comprising the steps of:
pouring silicone rubber into a depressed groove of a predetermined shape formed on a depressed mold, thereby forming a silicone rubber layer;
applying colored silicone rubber in a substantially thin thickness to the surface of said silicone rubber layer hardened, thereby forming a color layer;
applying silicone rubber in a substantially thin thickness having a predetermined color to the surface of said color layer hardened, thereby forming a coupling layer; and
applying a thermoplastic resin before said coupling layer is hardened, thereby forming a thermal bond layer, whereby said coupling layer is hardened with said thermal bond layer, thereby ensuring more rigid adhesion between said thermal bond layer and said coupling layer.

2. The method as defined in claim 1, further comprising the step of applying, before said coupling layer is hardened, a thermoplastic resin, which is made of the same material such as polyester, urethane or epoxy as said thermoplastic resin of said thermal bond layer, on said coupling layer, thereby forming a thermoplastic resin layer between said coupling layer and said thermal bond layer.

3. The method as defined in claim 1, wherein said color layer is formed on a space between the silicone rubber layers.

4. The method as defined in claim 1, wherein on the surface of said thermal bond layer base paper with an adhesive layer is attached, the label is separated from said depressed mold, and after that, in that state where the label turns over, on the surface of said silicone rubber layer release paper with a heat-resistant adhesive layer is attached.

5. Heat transfer paper for a label made of a thermosetting material, said heat transfer paper comprising:
a silicone rubber layer adapted to be protruded in a predetermined shape by means of a depressed mold;
a silicone color layer applied in a substantially thin thickness on the reverse side of said silicone rubber layer;
a silicone coupling layer applied in a substantially thin thickness on the reverse side of said silicone color layer; and
a thermal bond layer applied before said silicone coupling layer is hardened and made of a thermoplastic resin.
